(19) United States
(12) Patent Application Publication
(10) Pub. No.: US 2018/0128779 A1
(43) Pub. Date: May 10, 2018

(54) Microfluidics method for detecting chemicals in water in near real time

(71) Applicants: Richard Alan Haimann, Huntington beach, CA (US); Bo Li, Bellevue, WA (US)

(72) Inventors: Richard Alan Haimann, Huntington beach, CA (US); Bo Li, Bellevue, WA (US)

(21) Appl. No.: 15/619,473

(22) Filed: Jun. 10, 2017

Related U.S. Application Data
(63) Continuation of application No. 62/313,809, filed on Jun. 11, 2016.

(51) Int. Cl. G01N 27/49; G01N 27/30; B01L 3/00

(52) U.S. Cl. CPC G01N 27/49; G01N 27/301; B01L 2200/16; B01L 3/502738; B01L 2400/0415; B01L 3/50273

(57) ABSTRACT

This invention relates to a method and system for measuring concentrations of total recoverable metals in fluids in real time. The method employs microfluidics channels with electrically actuated valves and pumps. The method employs on board pumps to draw a fluid sample into the device. The method employs logic circuits and memory circuits with computer code that control the opening and closing of on-board valves, the turning on and off of on-board pumps, and the direction in which onboard pumps propel fluids. The method employs on-board storage of reagents and, by controlling pumps and valves, mixes reagents with a fluid sample on board the device to prepare the sample for analysis. The method employs electrochemistry with one or more active electrodes, one or more inert electrodes, and one or more reference electrodes to measure concentrations of metals in solution, pH of solution, temperature of solution, and electroconductivity of solution. The method transmits information from the device to remote servers using telecommunications protocols and transceiver devices. The method employs pattern recognition algorithms to identify the correlations between voltage or current measurements on the device and concentrations of metals in the sample in the device. The method employs one or more ultrasonic transducers connected to the microfluidic channels and electrodes used to mix samples with reagents clean the device and maintain its viability.

### REFERENCE TO RELATED APPLICATIONS

This application claims priority to U.S. Provisional Patent Application No. 62/313,809 filed on Jun. 11, 2016.

### FIELD OF THE INVENTION

The field of the invention generally relates to devices used to detect concentrations of metals in fluids. More particularly, the invention relates to microfluidics based devices that detect metals in fluids in timeframes that would generally be understood to be “real-time” or within a timeframe that allows for the use of the information to control consumption or use of the fluid for some beneficial purpose.

### BACKGROUND OF THE INVENTION

Microfluidics based systems are becoming widely used in chemical analysis applications. Electrochemical methods for measuring metals concentrations in fluids have become widely used for a variety of metals concentrations measurement applications. Traditionally, to measure concentrations of total metals in fluids required preparation of the fluid sample to lower its pH so particulate metals dissolve, calculating dilutions occurring through reagent mixing, applying spectroscopic or electrochemical methods to detect spectral or electrical signals unique to specific metals in specific oxidation states, and mathematical analysis of the spectral or electrical signals to calculate the metals concentrations represented by the spectral or electrical signals as adjusted based on dilutions and calibration checks of the devices. This has required manual sample handling, reagent mixing, manually titrating to a specified pH, and the use of costly equipment to analyze samples with little real-time data availability. The need for real time measurement of target constituents in water and other fluids is necessary to enable automation and control of water purification systems, food processing systems, and to provide information to people to make choices over products they wish to consume relating to the health and safety of those products. What is currently lacking for real time devices is the integration of a set of systems that, when working together, enable mostly automated drawing of a sample, mixing of the sample with necessary reagents lower its pH to dissolve particulate metals, measurement of the electrochemical properties of the sample after its preparation, analysis of the electrochemical properties rapidly to return the concentrations of metals represented by those electrochemical properties, and cleaning and flushing of the device to prepare it for future samples.

Prior art has resulted in the development of the following elements related to this invention.

Zou et al., IEEE Sensors Journal, Vol. 9, No. 5, May 2009, 586-594 discloses a microfluidics cell applying reversed anodic stripping voltammetry across three electrodes—a bismuth active electrode, a gold inert electrode, and a silver/silver chloride reference electrode for the detection of led. He mixes samples off board to demonstrate the microfluidics cell for metals detection.

U.S. Pat. No. 9,211,539 discloses a method for programmable mixing fluids in a microfluidics device. The method uses valves and pumps to move fluids from reservoirs to channels and a mixing chamber. Mixing is accomplished by the hydrodynamic movement of fluids through the actions of the valves and pumps. No other mixing methods are employed.

U.S. Pat. No. 9,192,933 B2 discloses a microfluidic electrochemical device for the detection of one or more chemicals. The device requires external sample preparation. The device uses a hydrophilic porous layer, such as paper, to transport fluids to the electrode interface for measurement of changes in electrical potential changes caused by chemicals in the fluid.

U.S. Pat. No. 9,134,267 discloses a microfluidic electrochemical device for the detection of metals using anodic stripping voltammetric analysis of metals selectively captured within polymer nanopores.

U.S. Pat. No. 8,128,794 discloses a bismuth electrode in a stripping voltammetry system for the detection of heavy metals in real time in water samples.

U.S. Pat. No. 8,097,148 discloses a method for cleaning working electrodes in electrochemical systems with connected ultrasonic transducers.

U.S. Pat. No. 8,092,761 discloses a method for a microfluidics valve consisting of a finger that is thermally actuated. The actuator, when a current is passed through it, temperature increases, which expands the material, resulting in raising the valve to close the valve.

U.S. Pat. No. 8,080,220 discloses a method for a microfluidics peristaltic pump consisting of moveable fingers, each of which is thermally actuated in order to convey fluids at a specified flow rate. The actuator, when a current is passed through it, temperature increases, which expands the material, resulting in raising the valve to close the valve.

U.S. Pat. No. 8,016,998 discloses a method for electrochemical detection of arsenic using platinum or indium tin oxide and gold active electrodes. In this method, the compounds that would typically interfere with detection of Arsenic (III) on other active electrodes do not interfere with its detection on these electrodes.

U.S. Pat. No. 7,897,032 discloses a method for electrochemical detection of metals, metalloids, and other compounds using stripping voltammetry, with computer readable code analyzing the voltage or current changes occurring during sample preconcentration and stripping. This method includes autonomous sample dilution and re-analysis based on comparison to a reference value.

U.S. Pat. No. 7,883,617 discloses a method for electrochemical detection of arsenic using a boron doped diamond electrode with gold deposits.

U.S. Pat. No. 5,646,863 discloses a method for measuring contaminants in environmental samples using electrodes monitored remotely with electrode voltages or currents analyzed with a variety of methods, including artificial neural networks to compare the voltages or currents with known concentrations of chemicals or matrix interferences in the samples.

In 2008, Linyuan Cao, Jianbo Jia, and Zhenhui Wang published in Electrochimica Acta 53 (2008) 2177-2182 that Cd and Pb could be detected at single digit and decimal microgram per liter concentrations with differential pulse stripping voltammetry with in bismuth-modified zeolite doped carbon paste electrodes

In 2011, Preetha Jothimuthu & Robert A. Wilson & Josi Herren & Erin N. Haynes & William R. Heineman & Ian Papautsky published in Biomed Microdevices (2011) 13:695-703 that a lab on a chip sensor using anodic stripping voltammetry with a bismuth doped active electrode could detect Pb, Cd and Mn at micromolar ranges.

In 2008, Christos Kokkinos, Anastasios Economou, Ioannis Raptis, and Thanassis Speliotis published in analytica chimica acta 622 (2008) 111-118 that they could detect nickel at the 10 to 100 ng/1 range using anodic stripping voltammetry with a bismuth doped active electrode in a microfluidics environment.

In 2010, an article published by Ivan Svancara, Chad Prior, Samo B. Hocevar, and Joseph Wang in Electroanalysis 2010, 22, No. 13, 1405-1420 titled A Decade with Bismuth-Based Electrodes in Electroanalysis reports that researchers over r the prior decade had reported that bismuth doped active electrodes in anodic stripping voltammetry systems had detected As(III), Sb(III), Co(II), Pb(II), Tl(I), Cd(II), Cr(VI), and Se(IV) at 10x-9 to 10x-10 M concentrations.

In 2015, Andrea Mardegan, Mattia Cettolin, Rahul Kamath, Veronica Vascotto, Angela Maria Stortini, Paolo Ugo, Paolo Scopece, Marc Madou, and Ligia Maria Moretto published in Electroanalysis 2015, 27, 128-134 that Pyrolyzed photoresist carbon electrodes modified with bismuth (Bi-PPCEs) were prepared and used to detect chromium(III) at 0.1 ug/l.

In 2013, Ping Qiva, Yong-Nian Nia, and Serge Kokotcpublished published in Chinese Chemical Letters, Volume 24, Issue 3, March 2013, Pages 246-248, the application of an artificial neural network to detect three pesticides in mixtures by linear sweep stripping voltammetry despite their overlapped voltammograms.

In 2006, Ali A. Ensafi, T. Khayamian, A. Benvidi, and E. Mirmomtaz published in Analytica Chimica Acta, Volume 561, Issues 1-2, 2 Mar. 2006, Pages 225-232 work demonstrating simultaneous determination of two groups of elements consisting of Pb(II)-Cd(II) and Cu(II)-Pb(II)-Cd(II) using adsorptive cathodic stripping voltammetry at limits of detection of 0.98 and 1.18 ng per ml for lead and cadmium ions, respectively. They used an artificial neural network to optimize as the multivariate calibration method.

In 1995, Howard S. Manwaring published a Ph.D. thesis at the University of Hertfordshire, United Kingdom, entitled: “The Application of Neural Networks to Anodic Stripping Voltammetry to Improve Trace Metal Analysis.” In the work it was demonstrated that the use of an artificial neural network for correlations between voltage changes during stripping voltammetric reactions were two-fold stronger than using standard regression techniques against standards. The artificial neural network also enabled accurate detections in ranges where voltage volatility was above ranges that allowed statistical regression techniques to be successfully employed.

In 2016, Guo Zhao, Hui Wang, Gang Liu, and Zhiqiang Wang published in Sensors 2016, 16, 1540; doi:10.3390/s16091540 work demonstrating optimization of a stripping voltammetric sensor employing bismuth and glassy carbon as active electrodes by a back propagation artificial neural network for accurate determination of lead (II) in the presence of cadmium (II).

In 2015, Takahiro Yamaguchi, Masahiro Shibata, Shinya Kumagai, and Minoru Sasaki published in Japanese Journal of Applied Physics 54, 030219 (2015) “Thermocouples fabricated on trench sidewall in microfluidic channel bonded with film cover” where they describe methods for sensing temperature electronically in a microfluidics system.

### SUMMARY

In the one embodiment of the invention, a microfluidics integrated device is employed to, upon the pressing of a single control button or switch, autonomously draw in a sample of a fluid, mix that fluid with reagents to lower its pH to the point where particulate metals will dissolve into solution, facilitate rapid mixing with mechanical or ultrasonic means, move the prepared sample to electrochemical chambers that consist of one or more active or counter electrodes, one or more inert electrodes, and one or more reference electrodes, allow the metals to pre-concentrate in the chambers where they will deposit upon some electrodes, apply a set of one or more stripping voltages to the electrodes to strip the metals from the electrodes to which they had deposited, and measure the changes in voltage drop or current flow across the electrodes during the preconcentration and/or stripping phases, then move the sample to a waste chamber, and then flush the entire microfluidics system with water to prepare it for the next sample, and clean the channels and chambers that came into contact with sample with ultrasonic methods. One embodiment further collects data from sample preparation including the volume of sample drawn, the volume of reagents mixed with the sample, the pH of the sample, the electroconductivity of the sample before mixing it with reagents and after mixing it with reagents, the time over which preconcentration occurs, the voltage drops or current flows in the electrodes throughout the preconcentration phase, the stripping voltages applied to the electrodes, and the voltage drops or current flows in the electrodes during the striping phases. The embodiment transmits this data using a telecommunications protocol such as Bluetooth to a user operated device, such as a smartphone, which in turn, using software associated with the embodiment, transmits the data to remote servers over an internet connection, where pattern recognition code correlates the data from the sample collection and analysis phase with a library of data to identify the concentration of metals being analyzed that correlate with those data. In one embodiment, the data is then transmitted from the remote server to the user's smart phone where code that is part of the embodiment notifies the user of the concentrations of metals being analyzed in the device. In other embodiments, the user obtains the results via a website or via small message service (SMS) on their cellular phone.

### BRIEF DESCRIPTION OF THE DRAWINGS

FIG. 1 illustrates a perspective view of one embodiment of the device from its exterior (2). It shows six reagent vials (4, 5, 6, 7, 8, 9), each of which is equipped with an eject button (10, 11, 12, 13, 14, 15) to facilitate removal and replacement. Sample is drawn through a syringe point placed on the nose (1). The sample is drawn when the on button is pressed (3). At the rear of one embodiment of the device is a waste discharge port (18) and a micro-universal serial bus (USB) connection for battery charging and system diagnostics.

FIG. 2 illustrates a perspective view of one embodiment of the device with the top cover (2) removed. In this view, the hinges that the vials are seated in (16) are shown as connected to the eject buttons (10, 11, 12, 13, 14, 15). In one embodiment, syringe points (17) are fitted at the base of each hinge setting that connect with microfluidics channels. In one embodiment, these syringe points pierce the vials, which are composed of a plastic material, such as PDMS, in a manner that anneals around the syringe point so fluid moves from the vial into the microfluidics channel to which the syringe point is connected without leakage.

FIG. 3 shows a closer up perspective view of one embodiment of the device that illustrates one of the vials (4), one of the hinge seatings (16), one of the eject buttons (10), and one of the syringe points (17).

FIG. 4 illustrates a closer up perspective view of one embodiment of the device inside one of the vials (4), the syringe point (17) connected to one or more microfluidics channels. In each microfluidics channel at the place where the syringe point connects to the microfluidics channel are peristaltic pumps (23) consisting of 3 or more fingers that are each actuated separately as specified in code loaded into a microcontroller. The pumps move fluid from the vial down the microfluidics channel at a specified flow rate for a specified period of time.

FIG. 5 illustrates a closer up perspective view of one embodiment of the device at the location where a syringe point (17) connects with the microfluidics channel. Peristaltic pump fingers are illustrated. In one embodiment, each peristaltic pump finger is composed of a block structure (56) an actuator (57) and two electrodes (58)—a positive and negative electrode. The electrodes pass a current through the actuator, which then heats, and upon heating expands, and whose expansion causes the actuator to bend upward. The upward bending occurs due to the adhesion of the actuator to the microfluidics frame that prevents the footings of the actuator from moving. Thus, expansion of the actuator material, causes it to bend. In one embodiment, the actuator material is PDMS. The peristaltic action occurs by each finger moving in sequence from upstream to downstream in the direction of flow. The number of motions of one actuator per second times the volume that one block displaces is the flow rate of the fluid.

FIG. 6 illustrates a perspective view of one embodiment of the device showing a close-up view of its interior layers. In one embodiment, it is composed of three layers, a microfluidics layer (21) in which are placed the microfluidics channels, chambers, and mixing chambers, a sealing layer (20) that provides a cover over the microfluidics channels and seals the channels and prevents fluid movement across channels, and an electronics layer (22) in which all electrical components, traces, sensors, switches, and microprocessors are placed. The electronics layer, in one embodiment, is sealed from contact with fluids except where contact is specifically intended to be in the metals detection chambers. Within this view, a peristaltic pump (23) is shown and two electrically actuated valves (24) are shown.

FIG. 7 illustrates a perspective view of one embodiment of the device showing a close-up view of a peristaltic pump (23) and an electrically actuated valve (24) are shown. In this view, the blocks that hold or allow the movement of fluid (56), the actuators that, upon the application of current, expand and force the blocks up (57) are shown and the electrodes that provide current to the actuators (58) are shown beneath the sealed bottom of the microfluidics layer.

FIG. 8 illustrates a perspective view of one embodiment of the device showing a close-up of three channels at the front of one embodiment of the device. The central channel (25), in one embodiment carries sample drawn through the nose (2) to the mixing chamber as moved by the peristaltic pump (23). The two side channels (26, 27), in one embodiment, carry pure water from storage vials (4, 5 in one embodiment), to the nose to clean the system after a sample is drawn and analyzed. The valves in one embodiment (24) are actuated to be closed when drawing a sample and open in the side channels (26, 27) when cleaning the system.

FIG. 9 illustrates a perspective view of one embodiment of the device showing the sample draw channel (25) and device cleaning channels (26, 27) leading to the vials.

FIG. 10 illustrates a perspective view of one embodiment of the device showing a close-up view of the mixing chamber (28) to which microfluidics the microfluidics channel carrying sample (25) microfluidics channels carrying pure water (29, 30 in one embodiment), microfluidics channel carrying buffering solution (35 in one embodiment), microfluidics channel carrying acid (36 in one embodiment), metals analysis channels (39, 40, 41, 42, 43, 44, 45, and 46 in one embodiment) are shown, microfluidics channel carrying a standard solution for calibration checks (37 in one embodiment) and microfluidics channel carrying excess sample not analyzed and waste water from system flushing (38 in one embodiment) are shown. In one embodiment, each channel that carries fluids into the mixing chamber has an electrically actuated valve (24) at its junction with the mixing chamber. In one embodiment, each channel that carries fluid from the channel has a peristaltic pump at its junction with the mixing chamber. In one embodiment, the mixing chamber is of sufficient size to mix a sample for analysis in the metals detection chambers with excess capacity for dilutions.

FIG. 11 illustrates a perspective view of one embodiment of the device showing a close-up view of the mixing chamber (28), the microfluidics channel carrying acid to the mixing chamber (36 in one embodiment), the microfluidics channel carrying buffering solution to the mixing chamber (35 in one embodiment), the microfluidics channel carrying standard solution for calibration checks (37 in one embodiment), the microfluidics channel carrying excess sample not analyzed and wastewater generated during system flushing to the wastewater vial (38 in one embodiment), and the microfluidics channel carrying mixed and processed sample to the metals detection chambers (39 in one embodiment), and the metals detection chambers (40, 41, 42, 43m 44, 45, 46 in one embodiment). In one embodiment, a micro resistive temperature detector composed of a thermally sensitive metal such as Nickel-Silver is embedded into the side of the mixing chamber (28) and connected to electrodes through the electronics layer (22) beneath the microfluidics layer (21).

FIG. 12 illustrates a perspective view of one embodiment of the device showing a close-up view of the mixing chamber. In one embodiment of the mixing chamber are two electrodes for pH detection using electrochemical means—an active electrode (31) and a reference electrode (32). In one embodiment, these are inlaid into the mixing chamber and connected water-tightly through the bottom of the microfluidics layer to electrodes that measure the voltage or current changes in the electrodes that occur due to the concentration of hydronium or hydrogen ion in solution. In one embodiment, a method for electroconductivity measurement is shown in the mixing chamber (33 and 34). These are shown in one embodiment as plastic sections molded into the mixing chamber in which are placed a positive and negative electrode. The voltage drop between the plastic sections represents the electroconductivity of the fluids within the mixing chamber. In one embodiment, a method for temperature measurement is shown in the mixing chamber (62). One embodiment includes a method employing the use of a thermally sensitive metal such as Nickel-Silver embedded into the side of the mixing chamber (28) and connected to electrodes through the electronics layer (22) beneath the microfluidics layer (21).

FIG. 13 illustrates a perspective view of one embodiment of the device showing a close-up view of the metals analysis chambers and microfluidics channels adjacent to it. In one embodiment, one inert electrode (40), one reference electrode (41), and five active/counter electrodes are shown (42, 43, 44, 45, 46). Each active/counter electrode, in one embodiment, can be composed of a separate material to detect a broad range of constituents or two or more can be composed of the same material to extend the life of the system detecting a narrow range of constituents. In one embodiment, each metals detection chamber includes an electrically actuated valve at each end so that they can be used or not used for each sample based on the instructions in the code on the embodiment.

FIG. 14 illustrates a perspective view of one embodiment of the device showing a close-up view of the metals detection chambers with the wastewater discharge microfluidics channel (47) and reagent vials in view.

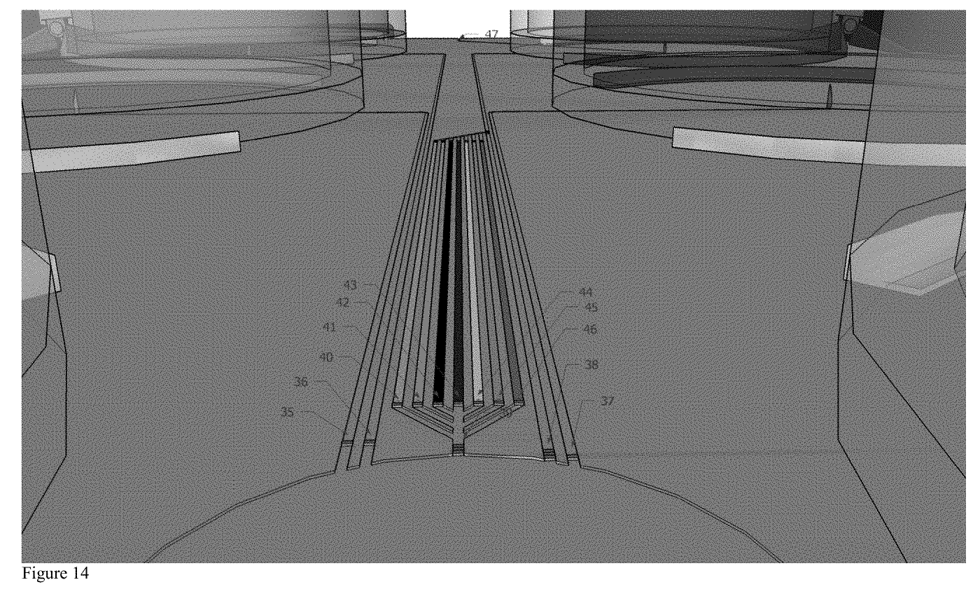

FIG. 15 illustrates a perspective view of one embodiment of the device showing a close-up view of the inlet section of one metals detection chamber (43). In one embodiment an electronically actuated valve is shown (25). The active electrode (43) is shown inlaid into the channel in one embodiment. Beneath the electrode is shown the potentiometer lead (61) in the electric layer (22) beneath the microfluidics layer (21). The electric lead (59) for the valve actuator (57) is pointed out in this view of one embodiment.

FIG. 16 illustrates a perspective view of one embodiment of the device showing a close-up view of the downstream end of the metals detection chambers. The waste discharge channel (38), which in one embodiment, the metals detection chambers exit into is shown The waste discharge channel (38) in one embodiment is fitted with a peristaltic pump (23) that conveys waste fluids from the metals detection chamber to the waste storage vial (8 in one embodiment). There is an electrically actuated valve (24) in the waste channel (38) to prevent wastewater from being flowing back into the mixing chamber. This valve (24) can also control waste flows so that excess sample not analyzed can be pumped to the waste vial (8) or system flush water can be pumped to the waste vial (8) during system cleaning cycles.

FIG. 17 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). Called out also in one embodiment are trace routes (50) that contain conductor traces connecting positive and negative leads on valves (59), pumps (58, 59), ultrasonic transducers (58), and potentiometric electrodes (61) to logic chips and power supplies.

FIG. 18 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). The ultrasonic transducer fitted beneath the mixing chamber (48) in one embodiment has a dual purpose in one embodiment—mixing sample and reagents and cleaning the mixing chamber during the cleaning cycle. Called out also in one embodiment are trace routes (50) that contain conductor traces connecting positive and negative leads on valves (59), pumps (58, 59), ultrasonic transducers (58), and potentiometric electrodes (61) to logic chips and power supplies.

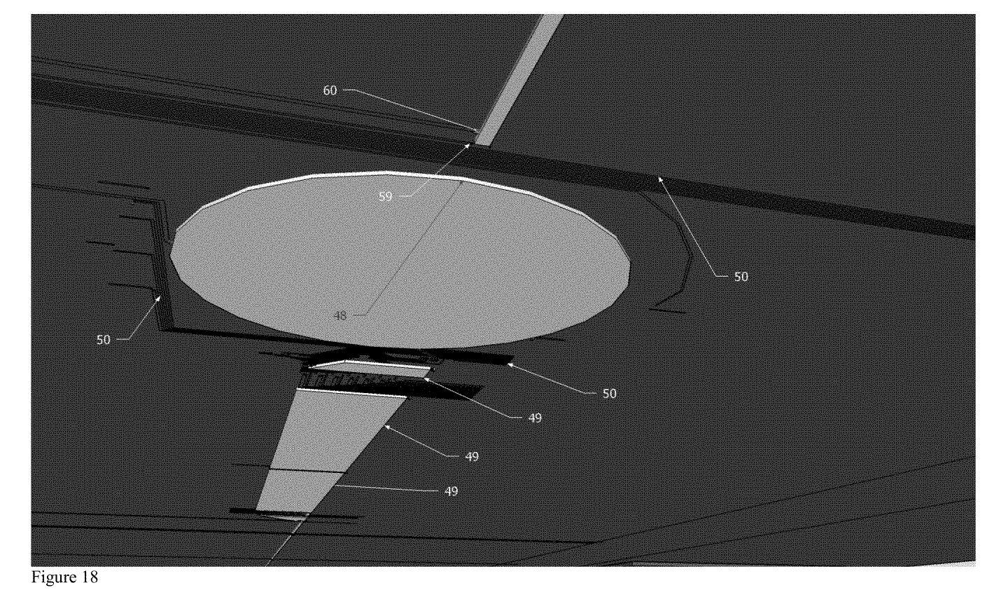

FIG. 19 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). The ultrasonic transducer fitted beneath the mixing chamber (48) in one embodiment has a dual purpose in one embodiment—mixing sample and reagents and cleaning the mixing chamber during the cleaning cycle. Called out also in one embodiment are trace routes (50) that contain conductor traces connecting positive and negative leads on valves (59), pumps (58, 59), ultrasonic transducers (58), and potentiometric electrodes (61) to logic chips and power supplies. In this view of one embodiment, logic chips are called out. The central processing unit (CPU) (51) turns off and on all switches and manages the stripping voltage in the metals detection electrodes. It also stores the information regarding pump activity and valve activity that is used to calculate the sample volume, reagent volume, and sample dilution. It tracks the date and time of sample draw, mixing, pre-concentration, stripping voltammetry, and cleaning cycles. The analogue to digital converter (52) shown in one embodiment samples voltage signals from the metals analysis electrodes, pH electrodes, and electroconductivity electrodes and converts those analogue signals into digital values for storage and transmission by the CPU (51). The power management chip (54) shown in one embodiment receives instructions from the CPU and turns off and on circuits for pumps, valves, and stripping voltages to the metals analysis electrodes. The Bluetooth transceiver chip (53) shown in one embodiment connects with a Bluetooth enabled device and transmits the data to that device for subsequent transmission to remote servers for data processing. The USB port (19) in one embodiment provides for connection of a power supply to recharge the battery and connection of a computer to run system diagnosis.

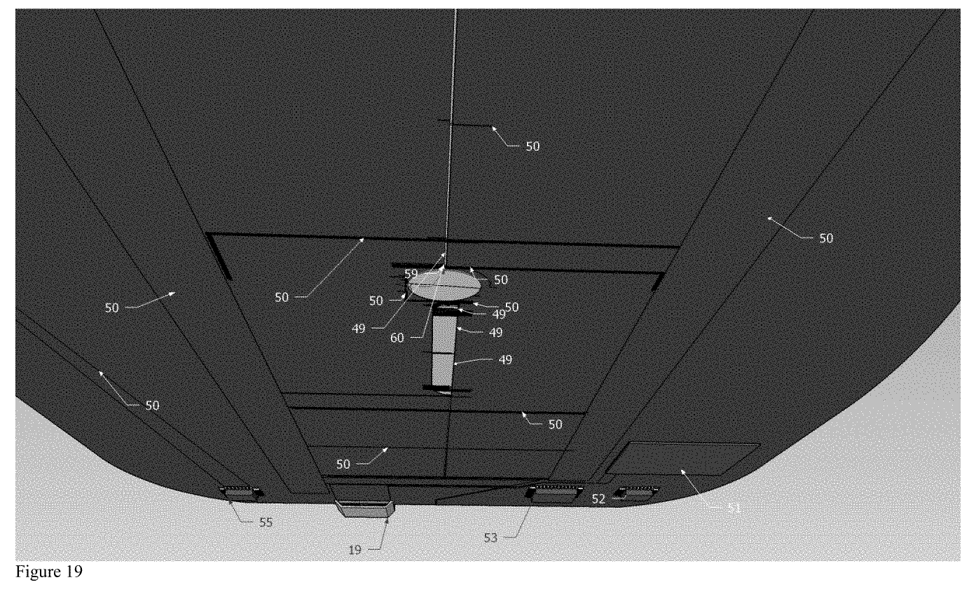

FIG. 20 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). Called out also in one embodiment are trace routes (50) that contain conductor traces connecting positive and negative leads on valves (59), pumps (58, 59), ultrasonic transducers (58), and potentiometric electrodes (61) to logic chips and power supplies.

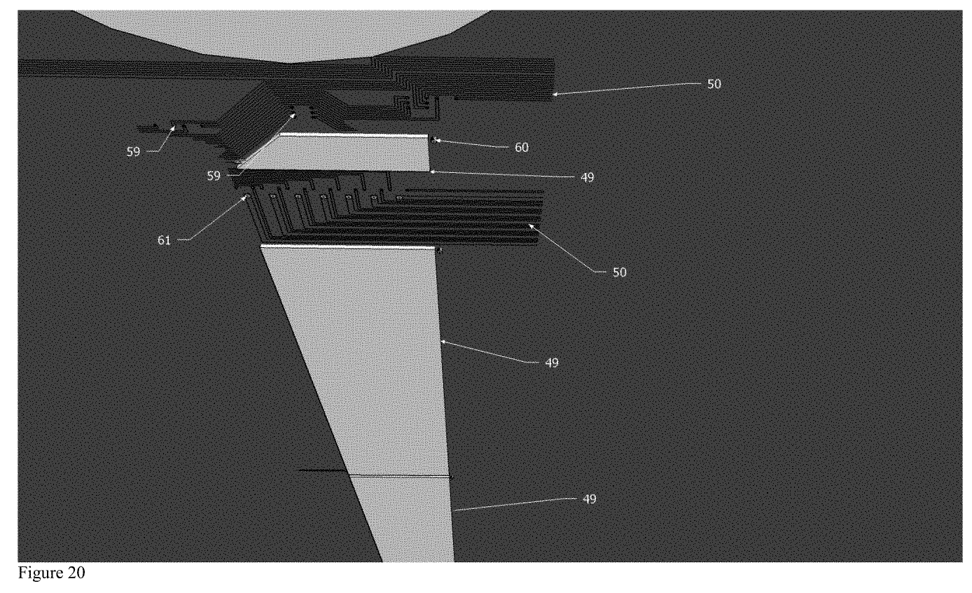

FIG. 21 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). Called out also in one embodiment are trace routes (50) that contain conductor traces connecting positive and negative leads on valves (59), pumps (58, 59), ultrasonic transducers (58), and potentiometric electrodes (61) to logic chips and power supplies.

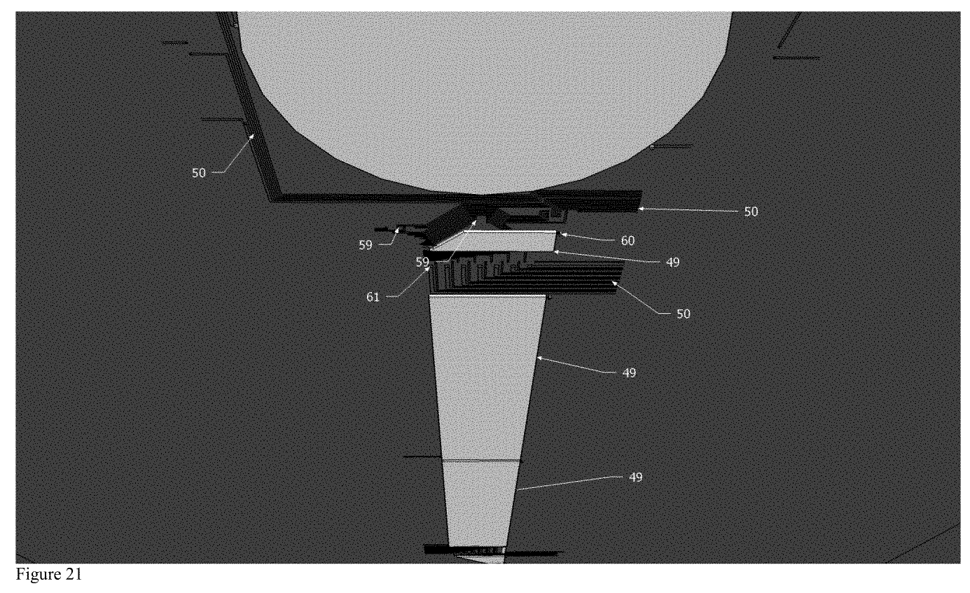

FIG. 22 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). Called out also in one embodiment are trace routes (50) that contain conductor traces connecting positive and negative leads on valves (59), pumps (58, 59), ultrasonic transducers (58), and potentiometric electrodes (61) to logic chips and power supplies.

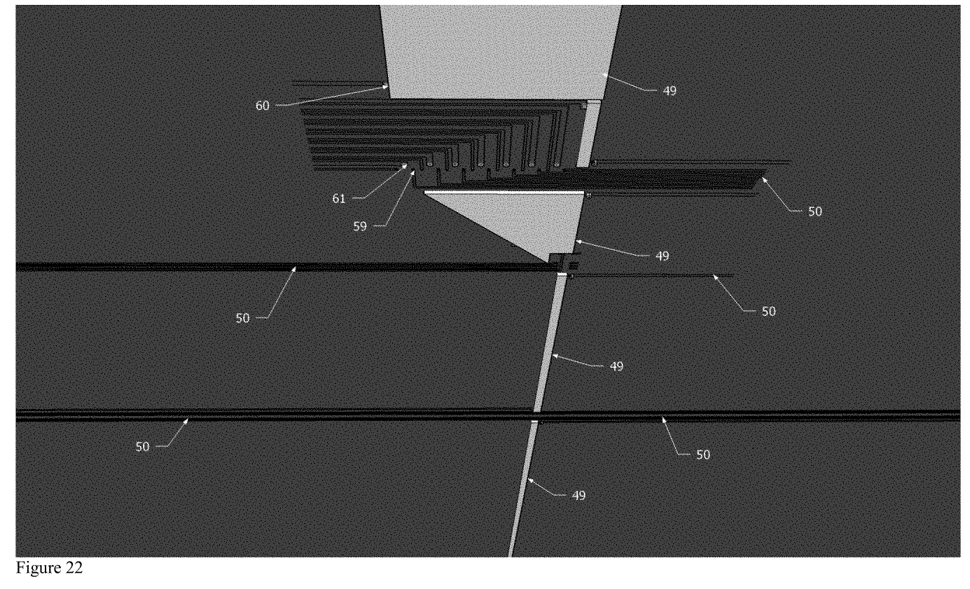

FIG. 23 illustrates a perspective view of one embodiment of the device showing a close-up view of the underside of the interior of the device showing the electronic layer (22). Called out are ultrasonic transducers (49) that are fitted along the channels that carry sample water and wastewater including the metals analysis chambers and mixing chamber (25, 28, 38, 39, 40, 41, 42, 43, 44, 45, 46, 47 in one embodiment). The ultrasonic transducer fitted beneath the mixing chamber (48) in one embodiment has a dual purpose in one embodiment—mixing sample and reagents and cleaning the mixing chamber during the cleaning cycle. Called out also in one embodiment are trace routes (50) that contain conductor traces connecting positive and negative leads on valves (59), pumps (58, 59), ultrasonic transducers (58), and potentiometric electrodes (61) to logic chips and power supplies. In this view of one embodiment, logic chips are called out. The central processing unit (CPU) (51) turns off and on all switches and manages the stripping voltage in the metals detection electrodes. It also stores the information regarding pump activity and valve activity that is used to calculate the sample volume, reagent volume, and sample dilution. It tracks the date and time of sample draw, mixing, pre-concentration, stripping voltammetry, and cleaning cycles. The analogue to digital converter (52) shown in one embodiment samples voltage signals from the metals analysis electrodes, pH electrodes, and electroconductivity electrodes and converts those analogue signals into digital values for storage and transmission by the CPU (51). The power management chip (54) shown in one embodiment receives instructions from the CPU and turns off and on circuits for pumps, valves, and stripping voltages to the metals analysis electrodes. The Bluetooth transceiver chip (53) shown in one embodiment connects with a Bluetooth enabled device and transmits the data to that device for subsequent transmission to remote servers for data processing. In other embodiments this transceiver chip (53) may use a different telecommunications protocol to fulfill the method of transmitting device voltage and current information to remote servers for analysis and return of answers to the users. The USB port (19) in one embodiment provides for connection of a power supply to recharge the battery and connection of a computer to run system diagnosis.

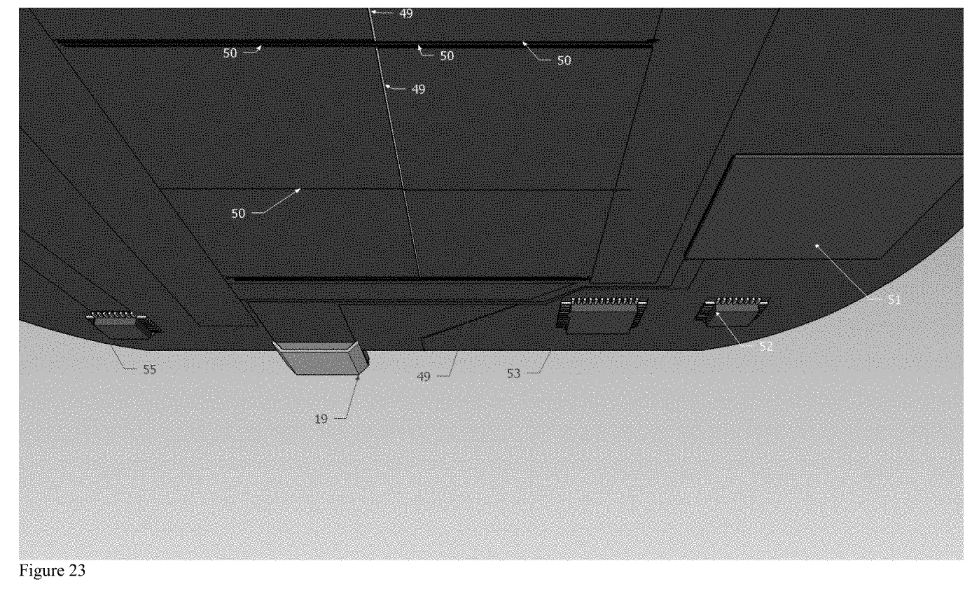

FIG. 24 illustrates a perspective view of one embodiment of the device showing a close-up view of the rear section of the device showing the three layers in one embodiment, the top sealing layer (20), the microfluidics layer (21), and the electronics layer (22) shown as they may be configured with the battery (55) beneath the electronics layer. The battery (55) in one embodiment is a rechargeable battery type, typically utilizing some type of lithium ion configuration and is molded to fit within the bottom body casing (2) of one embodiment.

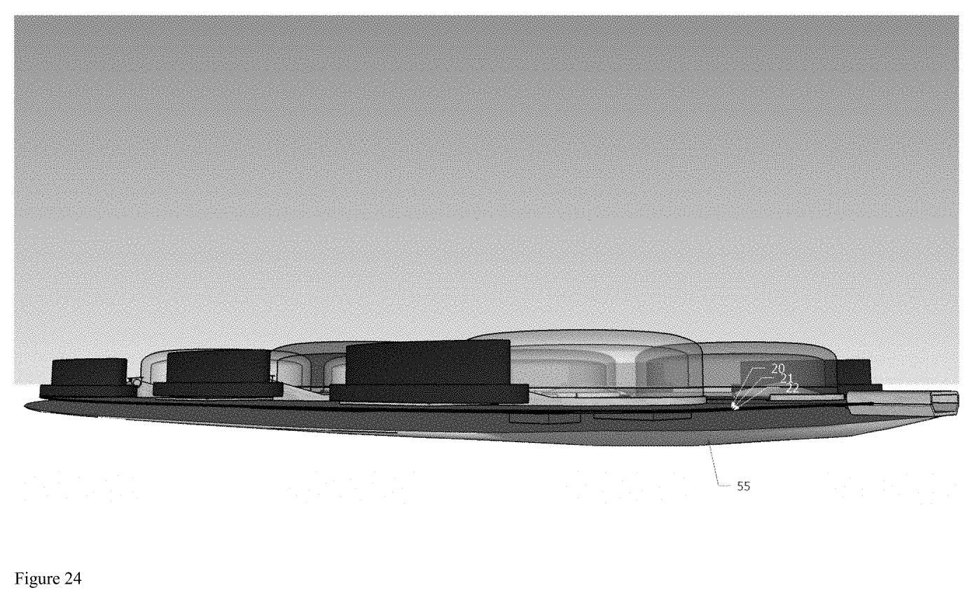

FIG. 25 illustrates a perspective view of one embodiment of the device showing a close-up view of the rear section of the device showing the three layers in one embodiment, the top sealing layer (20), the microfluidics layer (21), and the electronics layer (22) shown as they may be configured with the battery (55) beneath the electronics layer as it fits in one embodiment in the bottom section of the body casing (2).

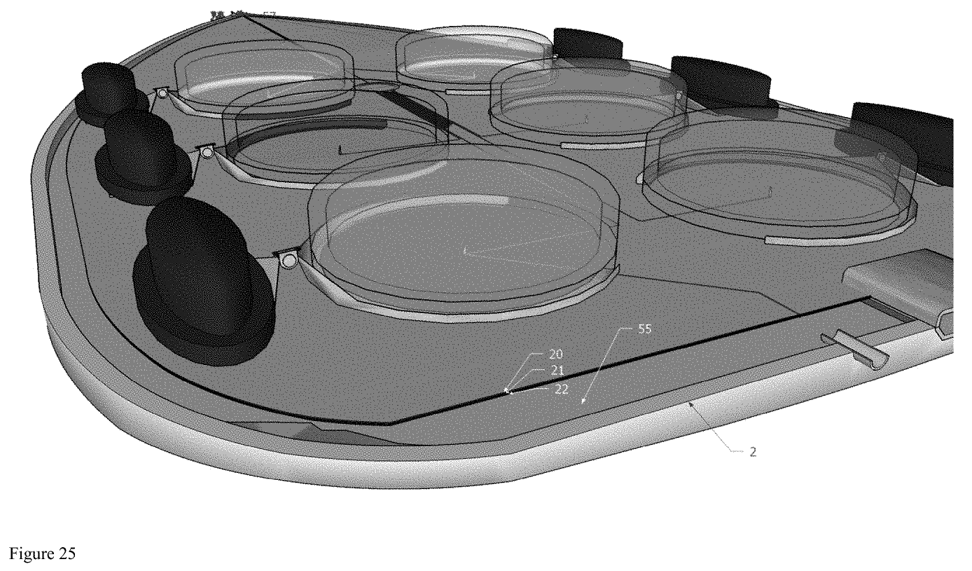

### DETAILED DESCRIPTION OF THE INVENTION

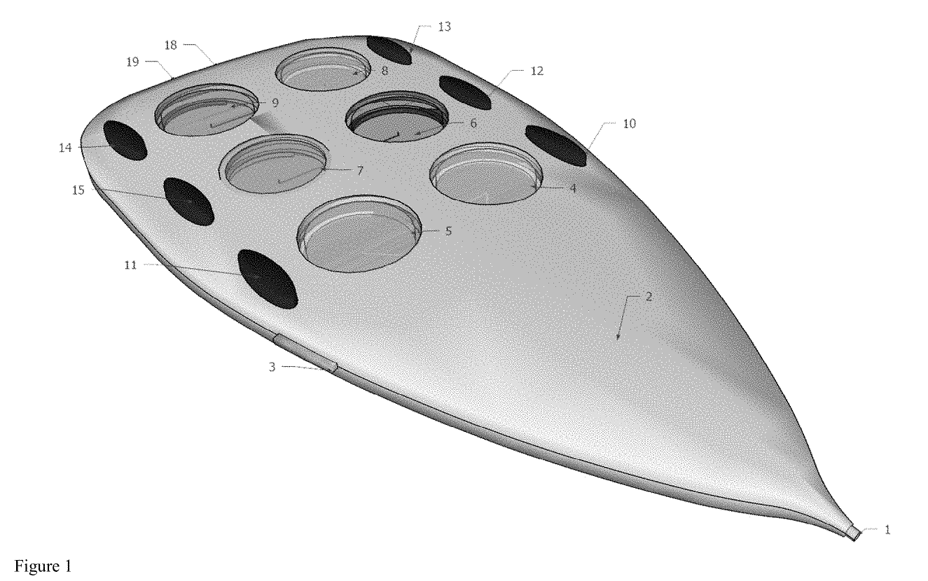

FIG. 1 illustrates one embodiment of the device exterior. One embodiment can be hand-held. Other embodiments can be permanently or semi-permanently attached to a pipe, fixture, or other container that contains a fluid of which knowledge of the concentration of metals in that fluid is desired. In one embodiment of a hand held model the overall dimensions are 140 mm long by 70 mm wide by approximately 8 mm thick. The exterior of the device can be constructed of any rigid material that contains insulation or material properties to prevent it from conducting electricity.

FIG. 1 illustrates six vials that are used to store reagents, pure water, or wastewater. Each vial is constructed of a polymeric material that will not leak fluids. The bottom of each vial contains a polymeric material that, upon puncture by a syringe point, will anneal around the syringe point and not leak fluids. One vial stores acid that is used to adjust pH of the sample downward to dissolve particulate metals. One vial stores a buffering solution that will limit pH change during the application of a stripping voltage to the electrode in contact with the fluid. One vial stores a standard solution containing known concentrations of target metals at a known pH that is used to run calibration checks by the device. Two vials contain pure water that meets the standards for typical laboratory grade high performance liquid chromatography deionized water. One vial stores wastewater until it is filled at which time. Each vial is removable and changeable using the eject buttons shown (10, 11, 12, 13, 14, 15). In one embodiment of a hand held model of the device, each vial is approximately 18 mm in diameter and 4 mm tall.

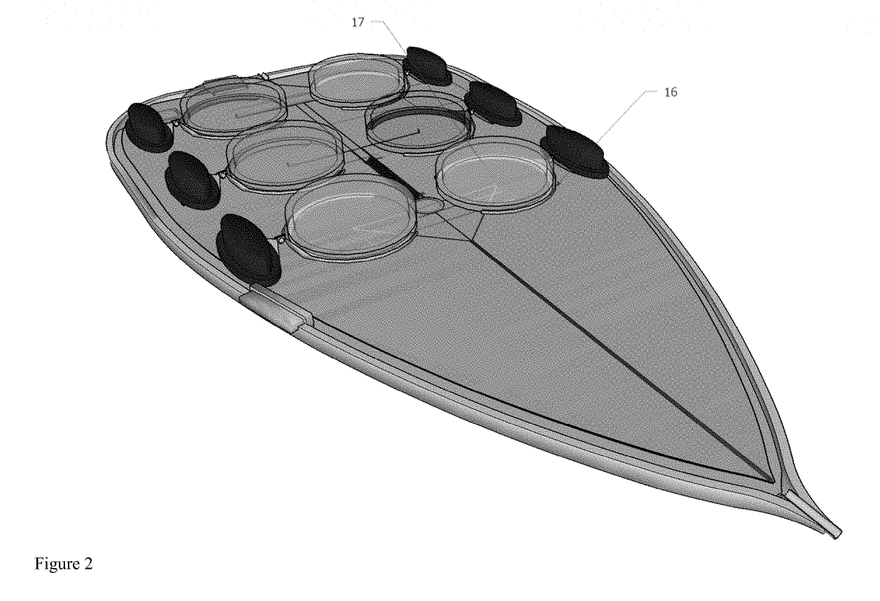

FIG. 2 shows the interior configuration of one embodiment.

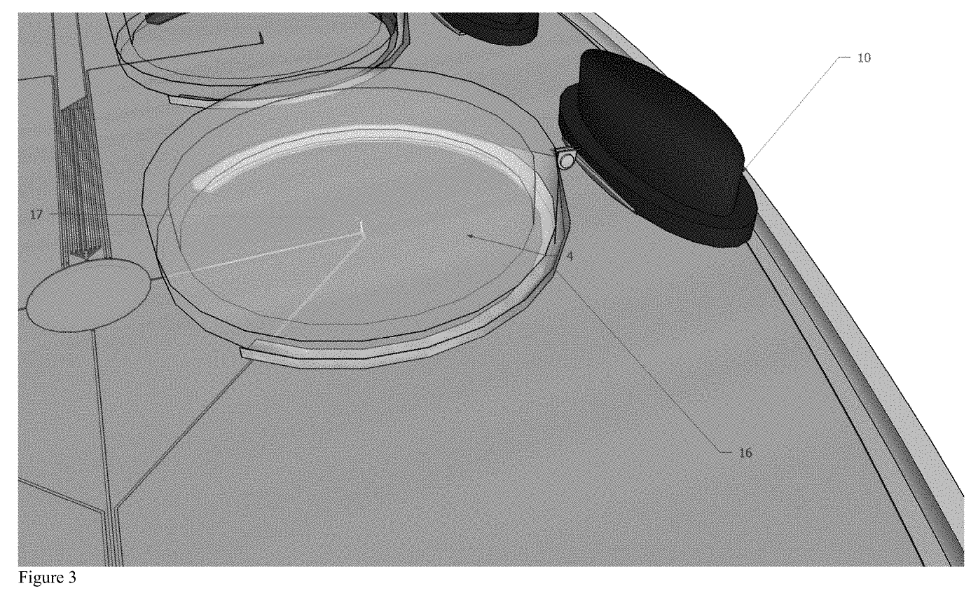

FIG. 3 shows a closer view of the vial, hinge, eject button, and syringe point configuration. The hinges (15) are made of a rigid material that can include metals or polymers or other materials that will not deflect more than two percent when pressing the eject button (10). The hinge is fitted and sized to the same diameter as the vials. The hinges are attached to the top of the body (2) of the device with an adhesive during manufacturing that can include a laminate, glue or molding of the body to include the hinge set into the body at the time of manufacture.

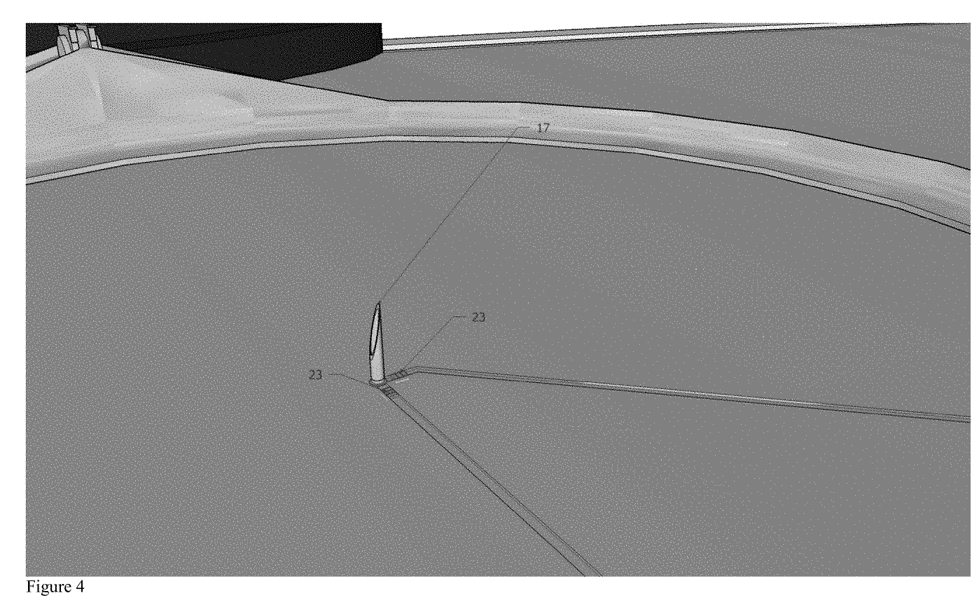

FIG. 4 shows a closer view of the syringe point (17) that punctures the bottom of the vial (4) to deliver fluids from the vial to the channels in the microfluidics layer of the device (21). The syringe points are constructed of stainless steel of ASTM A316. In one embodiment of a hand held model of the device, each syringe interior diameter is 0.100 mm and outer diameter is 0.120 mm. Each syringe point contains a collar as shown In FIG. 4 that holds the syringe point into the well in the microfluidics layer (21) and keeps the syringe point held in place by the top sealing layer (20). This collar is contiguous with the syringe point and a continuous part of the syringe point stainless steel. The dimensions herein are one embodiment and the method of the invention is the use of syringe points to pierce bottoms of vials in a manner that anneals around the syringe points and transmits the fluids from the vials through the syringe points into the underlying channels.

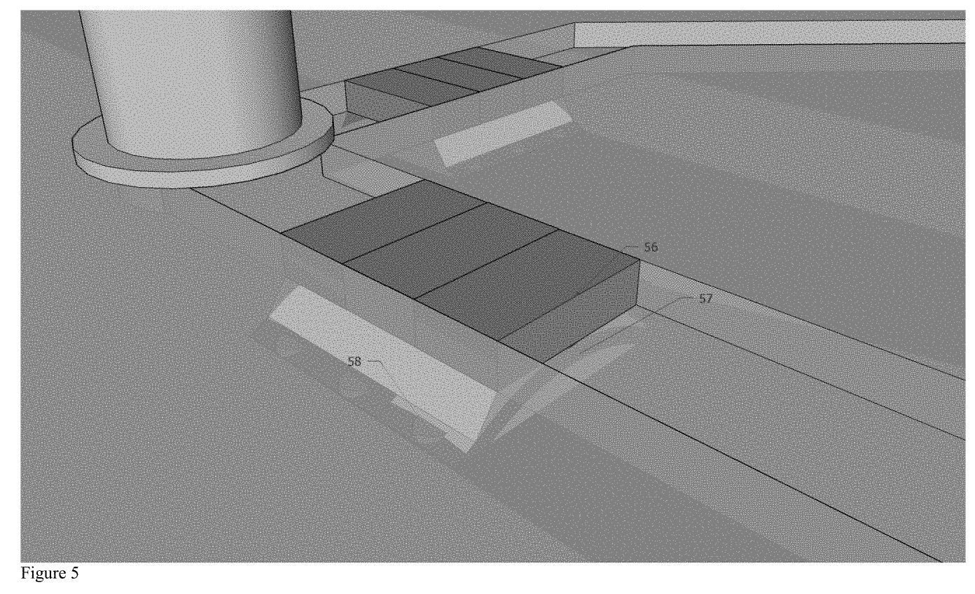

FIG. 5 shows in one embodiment the entry of the syringe point (17) through the top sealing layer (20) and into the microfluidics layer (21) in which a channel is formed (29). In this view of one embodiment, typical peristaltic pumps are shown. These are, in one embodiment, constructed of at least 3 fingers. Each finger can operate independent of each other. Each finger consists of a block (56) constructed of a relatively inert material that is rigid and does not deflect or expand or contract more than 1 percent upon heating to temperature ranges on the order of 40 degrees Celsius or cooled to temperature ranges on the order of 4 degrees Celsius. Such materials can include various polymers, glass, silica, or polycarbonate based materials. Each block has the same cross sectional area as the channel in which it resides. Beneath the block is a thermally expansive material such as PDMS or something equivalent that serves as the finger actuator (57). When an electric current is transmitted through this material, its resistance causes it to heat, and upon heating it expands such that it lifts the block up. When the current is cut off, it drops. This expansion and contraction occurs on the order of microseconds when small currents on the order of microamps are passed through the material and turned off. This actuator is annealed to the bottom of the microfluidics layer (21) and is fluid-tight against the sides of the microfluidics layer. It can be annealed through adhesion, direct molding within the forming of the microfluidics layer, laminating onto the microfluidics layer, or other techniques that affix the actuator material to the microfluidics layer such that they will not detach upon thermal expansion and contraction. One finger of each pump will be down at a time. The direction of the finger rise and fall cycles will drive flow in one direction or another. The flow rate will be the volume that one block displaces over the time the block cycles up and down. These pumps will be controlled by code programmed into the CPU (51).

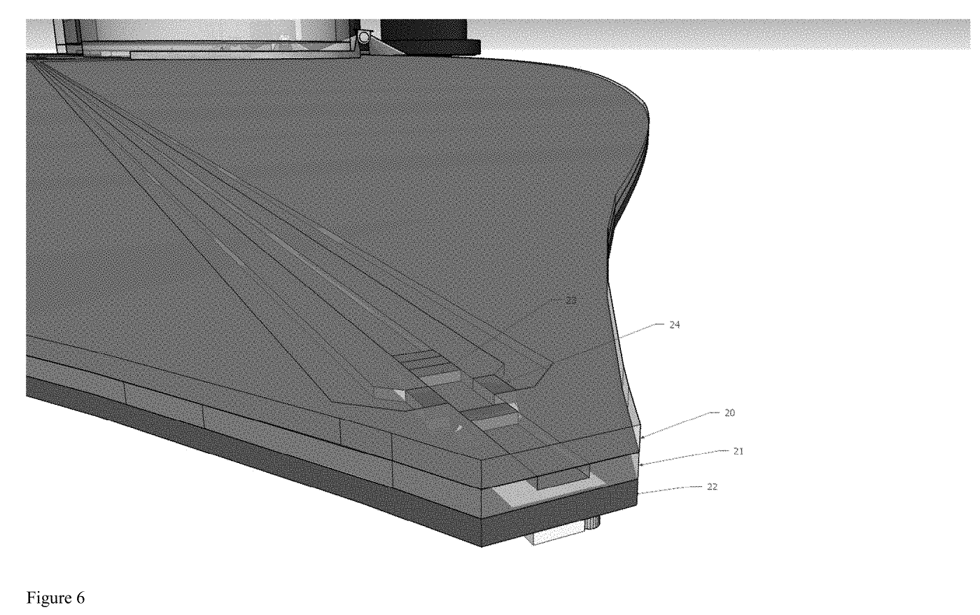

FIG. 6 shows the three layers at the nose of one embodiment of a hand held version of the device. The top sealing layer (20) is constructed of a relatively inert material that seals against the microfluidics layer and prevents leakage of fluids between channels. The thickness shown in one embodiment of a hand held version is 0.050 mm. In one embodiment, the top sealing layer does not include channels. It includes holes for the syringe points (17), and it includes a 0.025 mm hollow space fitted over the mixing chamber (28) in the microfluidics layer (21), which in one embodiment of a hand held version is 5.00 mm in diameter. The mixing chamber (28) in the microfluidics layer (21) in one embodiment of a hand held version is 0.025 mm deep by a 5.00 mm in diameter. The total mixing chamber (28) depth with the depth of the microfluidics layer (21) and the depth of the top sealing layer (20) is 0.050 mm. The microfluidics layer (21) in one embodiment is 0.050 mm thick and is constructed of generally inert materials that will not conduct electricity to any great degree. The material can be polymers, silica, borosilicate, or glass. The channels within the microfluidics layer are all in one embodiment 0.025 mm deep, and 0.100 mm wide. The electronics layer (22) is in one embodiment 0.050 mm thick and is constructed of materials typical for printed circuit boards such as fiber reinforced epoxy resin.

FIG. 6 further shows in one embodiment the peristaltic pump that conveys sample water from the inlet point (1) to the mixing chamber (28). The side channels shown in one embodiment carry pure water from storage vials to the main channel for flushing and cleaning between samples.

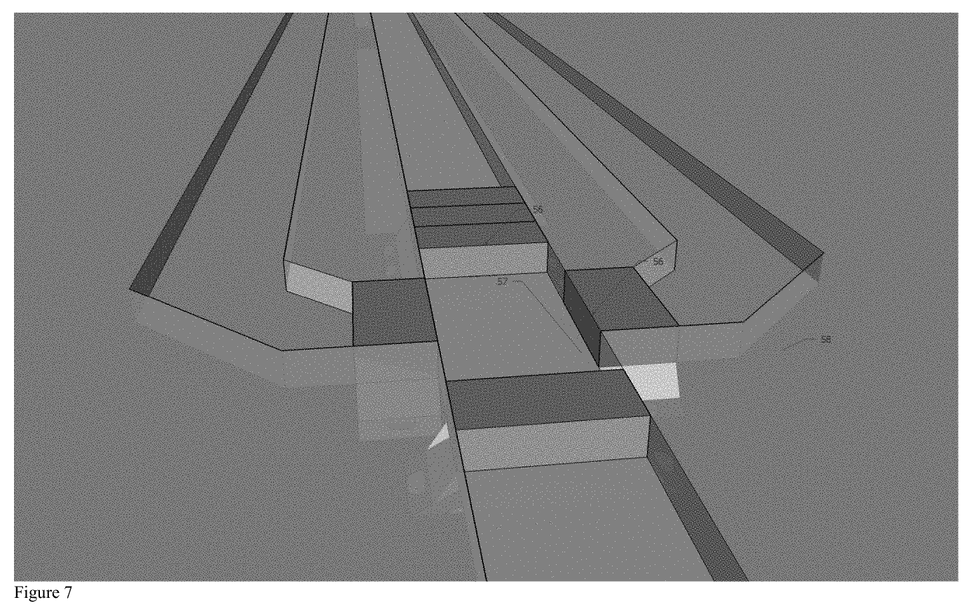

FIG. 7 shows in one embodiment the detail of peristaltic pump and valve. The valve uses the same actuator mechanism as the peristaltic pump and same materials. It one finger rather than three or more.

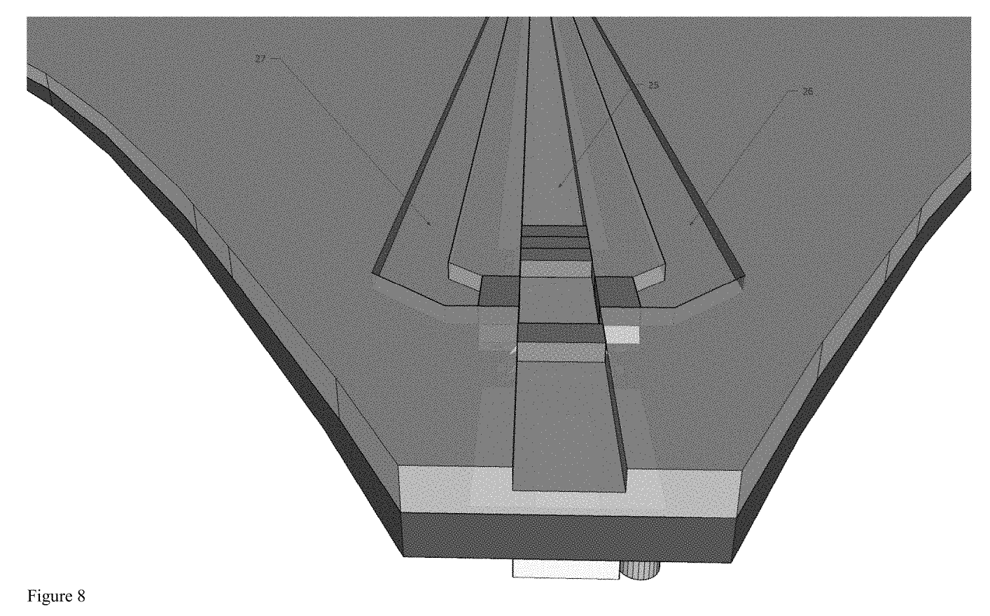

FIG. 8 shows a view in one embodiment of the front of the microfluidics layer (21) of the device showing the sample draw channel (25) and the system flushing channels (26, 27). All channels in one embodiment of the handheld device are 0.100 mm wide by 0.025 mm deep.

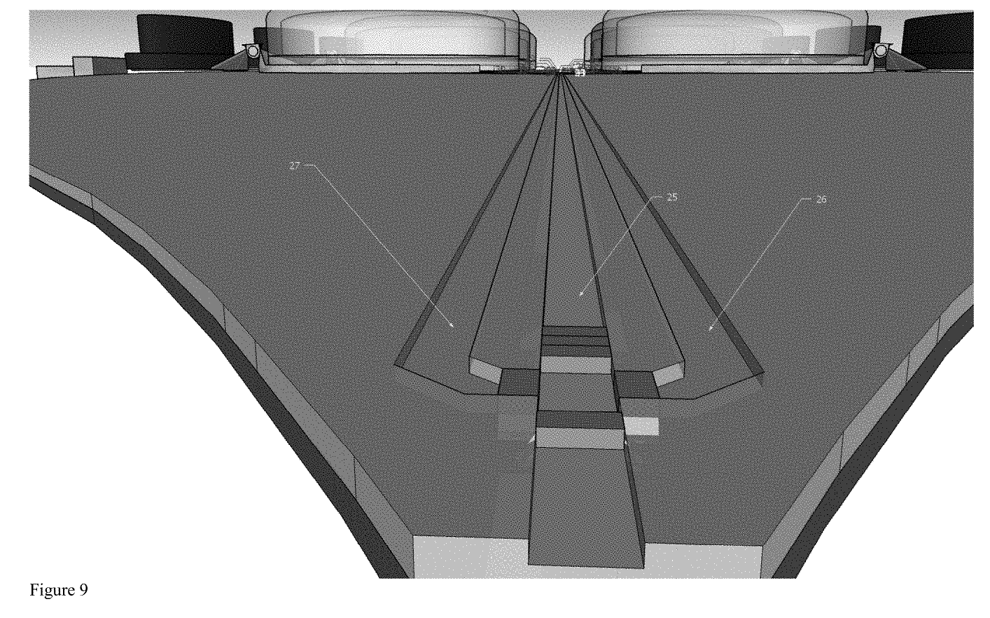

FIG. 9 shows another perspective of the front of the microfluidics layer (21) and layout of channels.

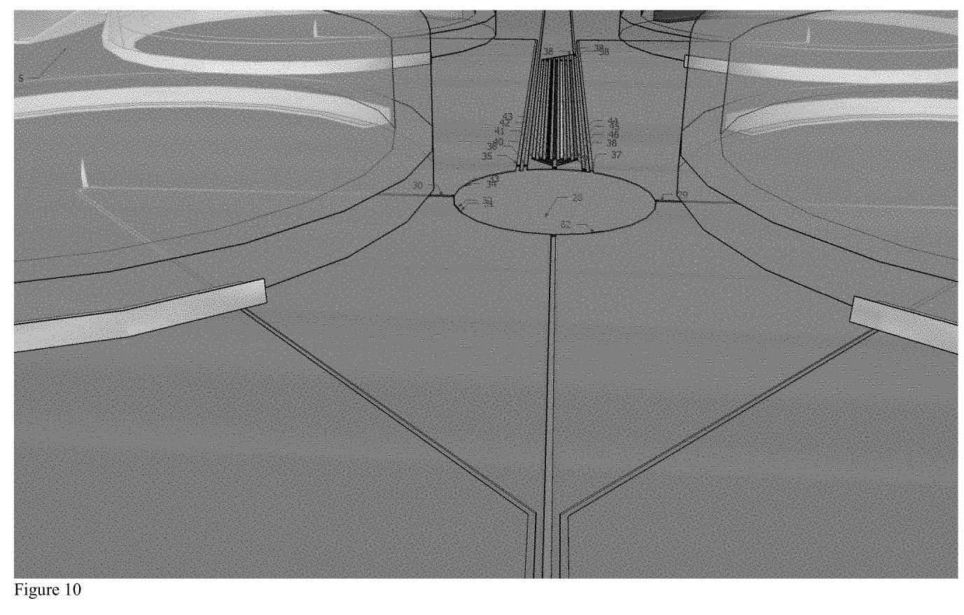

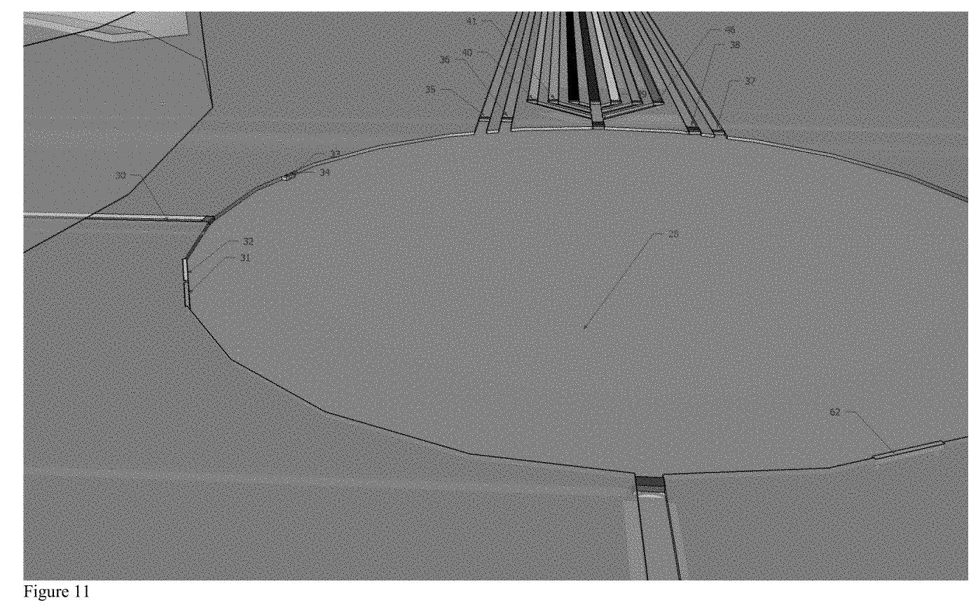

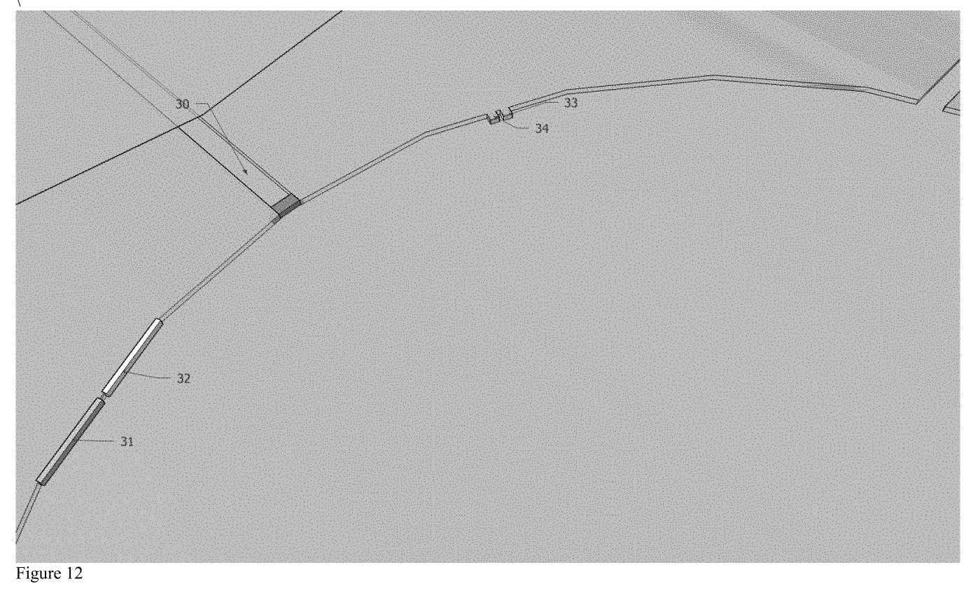

FIG. 10 shows the sample channel leading into the mixing chamber and the reagent channels leading into the mixing chamber. The mixing chamber collects sample, acid, buffering solution, and, if necessary, deionized water. The addition of acid is controlled by the pH electrodes (31, 32) shown in FIGS. 11 and 12. The pH electrode in one embodiment is composed of an active electrode such as zinc oxide and an inert electrode such as silver/silver chloride. In one embodiment, each electrode is approximately 0.314 mm long by 0.025 mm high. Each is inset and molded into the microfluidics layer in one side of the mixing chamber. Traces connect with the electrode in the electronics layer where the potential is measured between the ends of the electrodes. The potential is measured across each of the two electrodes. As hydronium ion varies from neutrality, the zinc oxide potential varies commensurately as compared to the potential across the silver/silver chloride electrode. This data is collected via an analogue to digital converter chip (52) and transmitted to the CPU (51), which controls the power to the pumps and valves and will open and close the pump and valve delivering acid to the mixing chamber to keep the pH within the specified range, which, in one embodiment for metals analysis, is below 2 and above 1. An ultrasonic transducer located beneath the microfluidics layer (21) embedded in the electronics layer (22) transmits sound waves across the mixing chamber, which mixes the sample, acid, and any other reagents. This is actuated by the code written on the CPU (51).

The buffer is controlled by the pH measurements. Steep swings in pH past the set points result in signals to dilute with buffer solution by 5%.

The electroconductivity of the solution is tracked in one embodiment with the electrodes leading to the structures shown in FIG. 12 (33, 34). These are protrusions sized in one embodiment 0.04 mm wide by 0.04 mm deep by 0.025 mm high. They are spaced in one embodiment approximately 0.02 mm apart. These dimensions may vary to achieve the desired function of measuring the electrical conductivity between electrodes within each protrusion. The voltage drop or current across the space between the electrodes correlates directly with the electroconductivity of the solution in the mixing chamber. Electroconductivity is tracked and used as one degree for correlation of voltammetric outputs with concentrations of metals in solutions as this is a parameter correlates with various ionic matrix interferences that may arise due to a range of compounds potentially in solution undergoing redox reactions as stripping voltages are applied.

The temperature of the solution is tracked on one embodiment with a thermally sensitive metal such as Nickel-Silver (62) embedded into the side of the mixing chamber (28) and connected to electrodes through the electronics layer (22) beneath the microfluidics layer (21). The resistance in the thermally active metal will vary commensurately with temperature. A current passed through the thermally active metal provides provide measurement of voltage drop across the metal, the change in which correlates with temperature. In one embodiment, the thermally sensitive metal is 0.314 mm long by 0.025 mm high by 0.020 mm deep. Electroconductivity is tracked and used as one degree for correlation of voltammetric outputs with concentrations of metals in solutions as this is a parameter correlating stripping voltammetric output and preconcentration voltammetric output.

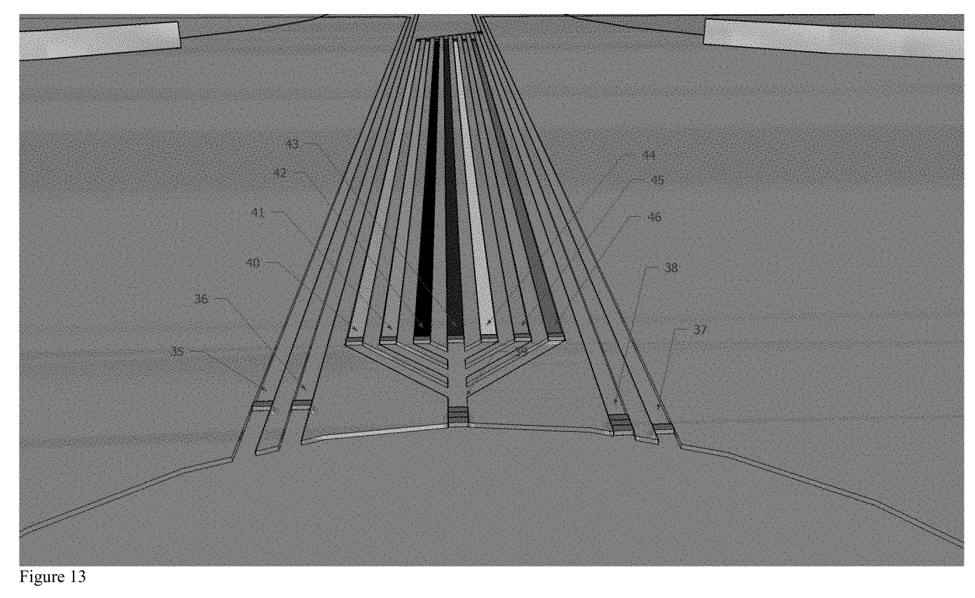

FIG. 13 shows in one embodiment the metals analysis chambers consisting of at least one inert electrode in one embodiment composed of gold or carbon, at least one reference electrode composed in one embodiment of silver/silver chloride, and at least one active electrode composed in one embodiment of bismuth. In one embodiment additional active electrodes are shown. They can consist of additional active electrode metals, which may include boron doped diamond, black carbon, rhodium, iridium, or other metals that exhibit specific electronegativity relative to the target metals to be analyzed. They can also be employed in one embodiment as spare active electrodes containing bismuth or another metal or carbon to extend the life of the system. The analysis of the voltammetric data will improve with additional active electrodes as each will exhibit unique responses to the metals in solution under both preconcentration and stripping voltammetry phases. Each metal analysis channel is shown in one embodiment of the hand held device to be 0.100 mm wide by 0.025 mm deep by 3 mm long. This length matches the theoretical rate of diffusion of several target metals to be analyzed across 0.025 mm of water under velocities produced by a 5 microliter per minute flow rate over the channel cross sections.

In one embodiment, each metals analysis chamber is fitted with valves at the upstream and downstream end to control the flow into and out of each chamber and set the preconcentration time and stripping time precisely. The sample after mixing with acid and, if necessary, buffer, will be pumped to the metals analysis chambers where it will fill the inert electrode, the reference electrode, and the active electrodes that are held open for the sample. Note, if some chambers are held as spares they will be kept closed during the analysis. The sample will be held for a period of time for preconcentration. In one embodiment, several seconds is anticipated for preconcentration, but the voltage drop changes occurring across the electrodes will determine when preconcentration will end and when stripping voltages will be applied to the electrodes. The voltage drop across each electrode is measured with poentiometric leads in the electronics layer (22). These voltages are sampled by the analogue to digital converter (52) with the digitized data sent to the CPU (51) for storage and transmission over the transceiver (53) to the remote server for processing.

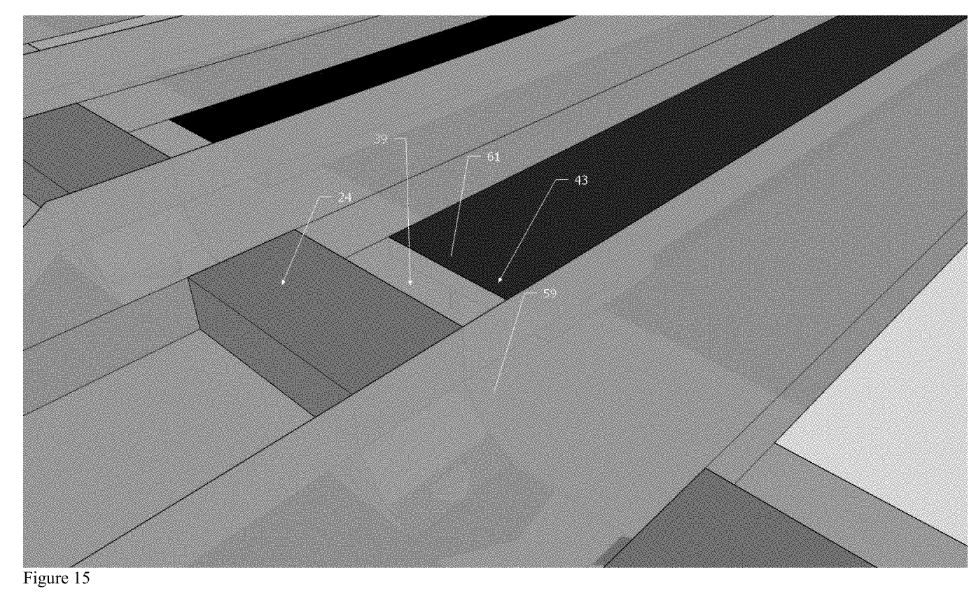

FIG. 15 shows a close-up view in one embodiment of a metals detection chamber with an active electrode. The electrode metals are embedded into the microfluidics layer by 0.010 mm in one embodiment. The depth can vary and still achieve the method of having a metal fluid interface that does not leak to the electronics layer. In the bottom of the electrode is attached a trace lead that is used as a potentiometer and voltage application lead in the electrode. The difference in voltage across the electrodes and between the active, inert, and reference electrodes provides the correlations with metals concentrations.

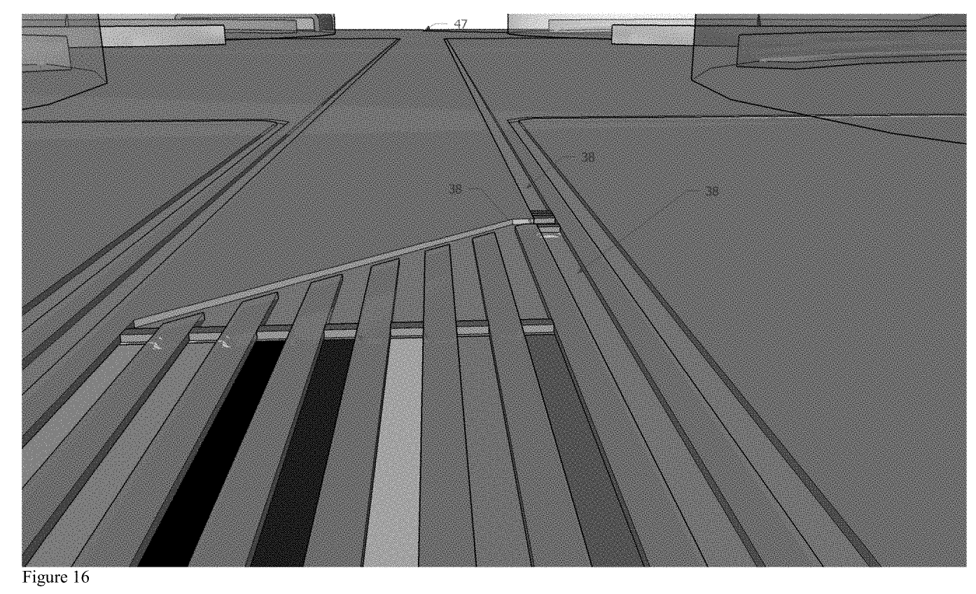

Once the stripping voltammetry peaks are brought back to pre-sample levels within set tolerances, the sample will be flushed to the wastewater storage vial and the system flushed with pure water. FIG. 16 shows in one embodiment the pumps and valve on the waste channel (38) that carries sample after analysis and excess sample not analyzed to the waste vial.

A standard vial (6) is included in one embodiment. Within this vial is a standard solution containing specific concentrations of the target metals at a set pH. At a specified interval after a fixed number of samples are analyzed, the standard is analyzed in the same manner as a target sample with the exception that it is not mixed with acid or buffer. The readings from the standard sample are transmitted to the remote sever for comparison with the libraries and adjustment of correlation factors that represent the differences in the standard sample concentration and instrument readings.

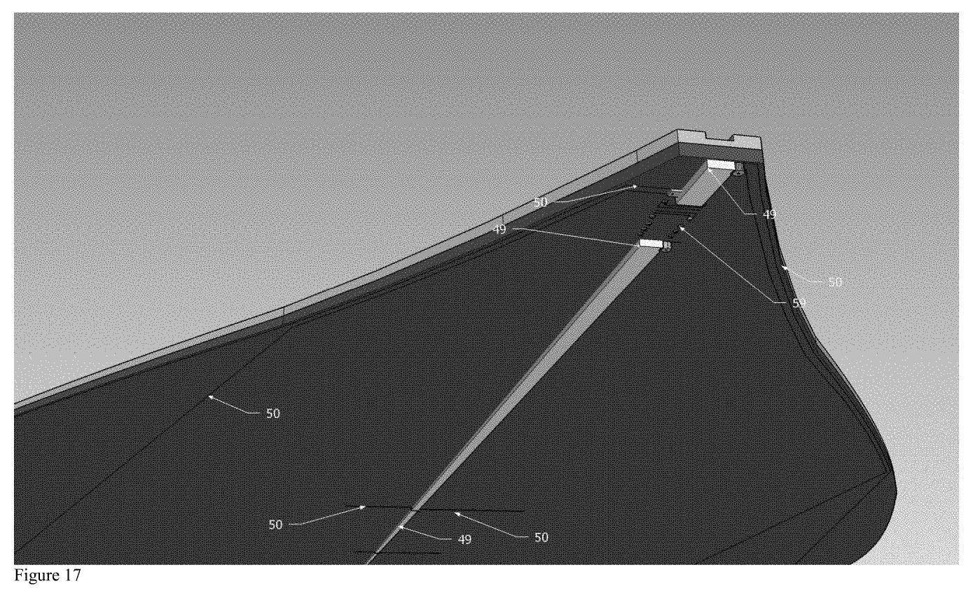

FIG. 17, 18, 19, 20, 21, 22, 23 show the electronics layer of one embodiment. Shown are ultrasonic transducers (48, 49), the conductors (58) that connect with the pump actuators (57), the conductors (59) that connect with the valve actuators (57), the conductors (61) that connect with the metals detection electrodes (40, 41, 42, 43, 44, 45, 46), the conductors (60) that connect with the ultrasonic transducers (48, 49) and the conductor traces leading from these conductors to the power supply, the CPU and other solid state switches in the electronics layer that turn power on and off to pumps and valves, turn off and on and adjust stripping voltages, and turn off and on ultrasonic transducers based on instructions from the code in the CPU. The ultrasonic transducer (48) under the mixing chamber (28) provides two functions in one embodiment—mixing fluids within the mixing chamber and cleaning the mixing chamber during cleaning cycles. The remaining ultrasonic transducers (49) in one embodiment provide a cleaning function and, in one embodiment, are placed along channels that carry sample or wastewater and over the metals analysis chambers. The ultrasonic cleaning cycle is programmed to take place at a specified time interval and when sufficient battery power is available for the cleaning cycle. The cleaning cycle consists of running the ultrasonic transducers to generate the sound waves while flushing the system with pure water.

Computer code is a part of one embodiment of the invention. Computer code consists three main elements.

ONE. There is code in the CPU that specifies when valves are to be turned on and off, when pumps are to be turned on and off and the rate at which pumps are to operate, when stripping voltages are to be applied to the metals detection electrodes and the frequency and size of those voltages, and when ultrasonic transducers are to be turned on and off for either mixing or cleaning purposes. This computer code captures and stores the information regarding valve open and close types, pump on and off time and frequency rates, ultrasonic transducer turn on and off times and frequencies operated at, stripping voltage application time and size, the temperature, the electroconductivity, temperature and the pH. The computer code then transmits this information to the cloud servers over the transceiver. In one embodiment, the transceiver uses Bluetooth protocols and communicates with as smart phone, which, in turn, transmits to remote servers over an internet connection.

TWO, in one embodiment there mobile application code in a user's smartphone that connects with the device and collects data transmitted by the device, adds user information that dataset, transmits that data to the remote server over an internet connection, and receives the output of the remote server back to the smart phone application to give the user information about the metals in the water they had sampled. In one embodiment, the mobile application code can also provide other information such as data from other samples the user has analyzed, data from samples analyzed by others, data from water utilities, information about the performance of the device based on the standard runs done by the device, instructions for maintaining the device or obtaining service on the device, or other information related to the device and that the user desires to capture associated with water quality or fluid quality of the substance they are interested in.

THREE, in one embodiment, there is pattern recognition code consisting of one or some combination of an artificial neural network, applied multivariate canonical correlation analysis, regression analysis, nonlinear regression analysis, principal components analysis, discriminate function analysis, multidimensional scaling, linear discriminate analysis, and/or logistic regression. The core of the pattern recognition code is an artificial neural network consisting of specific code that represents layers of neurons. There is an input layer, one or more hidden layers, and an output layer. The algorithms within each neuron set the connections between neurons to on or off states when the input nodes receive data signals. The algorithms for selecting connection states are set based on specified fuzzy sets of input parameters and output parameters. These are established from the library of know sample runs conducted on the device. Within these known relationships, fuzzy operators are applied to provide allowances for minor variances that do not result in rejecting of patterns as outside of range. External to the artificial neural network are a set of stochastic analysis of input data prepared from the library of known samples and sample runs under a diverse set of conditions. These stochastic analyses of system output variances from known samples are used to establish the fuzzy operators and establish the settings for the output neuron layer. The set of variables correlating with known metals concentrations include pH, electroconductivity, temperature, reference electrode readings, inert electrode readings, and the readings from one or more active electrodes. This set of multivariate signals are treated combinatorially by the neural network with the patterns established based on the library of known samples analyzed under a variety of conditions. This establishes the training phase of the pattern recognition algorithm. Upon completion of the training phase, the pattern recognition system is set to operating mode in which it receives the multivariate inputs and returns the concentrations of metals represented by those multivariate inputs based on the patterns observed during the training phase. Results out of range are returned as out of range.

What is claimed is:

1. A method to detect metals concentrations in fluids in real time.

2. The metals detection method of claim 1 wherein a microfluidics device with microchannels formed in substrate containing integrated therein:
A plurality of peristaltic pumps that convey fluids to specific locations at specific flow rates.
A plurality of valves that control the motion of fluids into or out of specific microchannels or chambers.
A mixing chamber with attached ultrasonic transducer to which microchannels are connected in which fluids are mixed with reagents under the action of the ultrasonic transducer
A metals detection chamber consisting of multiple electrode chambers in which stripping voltammetric methods are employed to detect metals concentrations in prepared samples.

3. The device of claim 2 whereby included is a central processing unit with logic circuits and memory circuits that, when enabled with computer code, controls the actions of all parts of the device.

4. The device of claim 2 whereby pumps and valves are controlled by electrical currents that are in turn controlled by a central processing unit with specific computer code that controls the valves.

5. The device of claim 2 whereby attached are replaceable vials containing pure water, acid, buffer solution, and other reagents that are necessary to prepare a sample for analysis and attached are replaceable vials containing standard solutions used for calibration checks.

6. The device of claim 2 whereby attached are ultrasonic transducers along channels used for cleaning of said channels.

7. The device of claim 2 whereby attached within the fluid handling elements of the device are
A pH sensor that detects the concentration of hydronium or positive hydrogen ions (pH) of the solution in the mixing chamber in real time.
An electroconductivity sensor that detects the electroconductivity of the solution in the mixing chamber in real time.
A temperature sensor that detects temperature of the solution in real time.

8. The device of claim 2 whereby included is a metals detection chamber containing
One or more inert electrodes that do change voltage drop across the electrode due to the presence or absence of metals in fluids in contact with said electrodes
One or more reference electrodes that change voltage drop across the electrodes consistently irrespective of the concentrations of metals in solution
One or more active electrodes that change voltage drop across the electrodes over time as metals in solution deposit onto the electrodes and, upon the application of a stripping current across the electrode and causes stripping of those metals from the electrode, changes voltage drop across the electrode as the metals strip from the surface of the electrodes.

9. The device of claim 2, whereby included are
Solid state switches and power modulation circuits that convert electrical currents from the power supply to stripping currents.
An analogue to digital converter that converts analogue electrical signals measured in the form of voltage or currents into digital representations of the values of voltage or current in the devices on the device that are measuring voltage or currents.
A transceiver with antenna that transmits data from the device to another device.
A Universal Serial Bus (USB) connection.
A rechargeable battery.

10. The device of claim 2, whereby included are
Circuits composed of conductors that connect to the metals detection electrodes, pH electrodes, electroconductivity electrodes, and temperature electrodes that provide current across electrodes.
Circuits composed of conductors that connect to the electrodes to measure the voltage at points in those electrodes.
Circuits composed of conductors that connect to valve and pump electrodes to provide current to operate the pumps and valves.
Circuits composed of conductors that connect to the metals detection electrodes to deliver stripping currents to those electrodes.
Circuits for converting power provided by the battery to the voltages and current required for each component on the device.
Circuits for bypassing the battery and operating from an external power support connected to the USB.
Circuits to deliver power from the power supply to all components on the device requiring a power source.
Circuits connecting the central processing unit with the power supply for each component on the device requiring a power source with solid state switches that turn on and off power to the components as directed by the computer code on the central processing unit.
Circuits from the USB connection to the battery via power modulation circuitry.
Circuits from the USB connection to the central processing unit for data transmission.

11. The device of claim 2, whereby included in the logic and memory circuits are
Computer code on the device that is directing the turning on and pumps and valves to mix sufficient acid with the sample to set the pH of the prepared sample to within a range of set points.
Computer code on the device that is directing the turning on and off pumps and valves to mix sufficient buffer with the sample to prevent pH changes outside a range of set points.
Computer code on the device that tracks and stores the data of volume of sample, volume of acid, volume of buffer, and volume of pure water used in the sample preparation.
Computer code on the device that turns pumps and valves off and on to draw a sample, mix the sample with reagents, analyze the sample, move the sample to a waste storage vial, flush the system with pure water, and clean the system based on system conditions or user direction.
Computer code on the device that turns pumps and valves off and on to analyze standard solutions kept in on board vials to check the calibration of the device.
Computer code on the device that turns on and off ultrasonic transducers at specified frequencies at specified times.
Computer code on the device that instructs the analogue to digital converter to sample a specific signal at a specified sampling rate and convert the measured signals to digital representations of the values those signals represents.
Computer code on the device that converts the voltage drops or current flows through the electroconductivity electrodes into electroconductivity data.
Computer code on the device that converts the voltage drops or current flows through the pH active and reference electrodes into pH data.
Computer code on the device that converts the voltage drops or current flows through the temperature electrode into temperature data.
Computer code on the device that operates switches and power modulators from the power source and to deliver specified stripping currents to the metals detection electrodes.
Circuits for converting power delivered from external sources to the voltage and current required to recharge the battery.

12. The method of claim 1, whereby computer code in remote servers captures data transmitted by the device in claim 2 and, using pattern recognition enabled with artificial neural network algorithms trained on a library of known samples, correlates that data with concentrations of metals in water.
